(19) United States
(12) Patent Application Publication
(10) Pub. No.: US 2020/0092160 A1
(43) Pub. Date: Mar. 19, 2020

(54) FAULT EVENT MANAGEMENT METHOD FOR CONTROLLER-BASED RESTORATION

(71) Applicant: ELECTRONICS AND TELECOMMUNICATIONS RESEARCH INSTITUTE, Daejeon (KR)

(72) Inventor: Bin Yeong YOON, Daejeon (KR)

(73) Assignee: ELECTRONICS AND TELECOMMUNICATIONS RESEARCH INSTITUTE, Daejeon (KR)

(21) Appl. No.: 16/573,658

(22) Filed: Sep. 17, 2019

(30) Foreign Application Priority Data
Sep. 18, 2018 (KR) 10-2018-0111787
Jun. 28, 2019 (KR) 10-2019-0077632

(51) Int. Cl. H04L 12/24; H04L 12/939; H04L 12/931; G06F 11/07; G06F 11/34

(52) U.S. Cl. CPC H04L 41/0663; H04L 49/552; H04L 49/354; G06F 2201/835; G06F 11/079; G06F 11/3476; H04L 49/70

(57) ABSTRACT

Disclosed is a controller-based fault management apparatus and method. The method according to an embodiment of the present disclosure may include: receiving information on a reason of a fault occurring in a network, generating restoration basis information on the fault on the basis of the information on the fault reason; determining whether or not to report a management system of the fault on the basis of the restoration basis information and filtering information, and generating subject to be reported classification information on whether or not the fault corresponds to a subject to be reported to the management system; and when the fault is determined to correspond to the subject to be reported on the basis of the subject to be reported classification information, transmitting information on a fault reason to the management system subject to be reported classification information.

### CROSS REFERENCE TO RELATED APPLICATION

The present application claims priority to Korean Patent Application Nos. 10-2018-0111787 and 10-2019-0077632, filed Sep. 18, 2018 and Jun. 28, 2019, respectively, the entire contents of which is incorporated herein for all purposes by this reference.

### BACKGROUND OF THE INVENTION

### Field of the Invention

The present disclosure relates to a rapid fault restoration method using a SDN controller (or network management system) when the fault occurs in a network.

### Description of the Related Art

Currently, in the G.7702 standard, two methods of restoring a network fault are proposed. The two proposed methods are data plane protection and controller-based restoration.

In data plane protection, in order to prevent network service interruption due to a network failure, a protection path (backup path) is set for all connection paths (working path) in advance. Accordingly, when a fault occurs in a working path, network equipment detects the fault, stops operation of the working path currently in operation, and switches from the working path where the fault has occurred to a backup path. Herein, rather than restoring the path where the fault has occurred by using a SDN controller, switching from the working path to a backup path is performed by using protocol between peer network equipments that monitors faults in a working path (for example, APS: Automatic Protection Switching).

On the contrary, in SDN controller-based restoration, unlike data plane protection where a path in which a fault has occurred is restored by network equipment, switching from a working path to a backup path is performed by the SDN controller.

SDN controller-based restoration can flexibly provide a protection path while improving efficiency in network resource usage when applying data plane protection is difficult, or when ensuring bandwidth for backup paths is difficult. However, in SDN controller-based restoration, it takes relatively long time from detecting a fault to restoring a path therefor, which leads to a long service disconnection time. To overcome the above problem, network equipment detecting a fault signal has to rapidly transfer the detected fault signal to the SDN controller.

### SUMMARY OF THE INVENTION

The present disclosure is to improve efficiency in network usage when a fault occurs in a network.

The present disclosure is to achieve rapid fault restoration by using a SDN controller (or network management system) when the fault occurs in the network.

The present disclosure is to rapidly transfer fault information to a SDN controller when network equipment detects the fault.

Technical solutions obtainable from the present disclosure are not limited the above-mentioned technical solutions, and other unmentioned technical solutions can be clearly understood from the following description by those having ordinary skill in the technical field to which the present invention pertains.

It is to be understood that technical problems to be solved by the present invention are not limited to the aforementioned technical problems and other technical problems which are not mentioned will be apparent from the following description to a person with an ordinary skill in the art to which the present invention pertain.

According to an aspect of the present disclosure, there is provided a controller-based fault management method performed by a controller-based fault management apparatus. The method includes: receiving information on a reason of the fault occurring in the network, and generating restoration basis information on the fault on the basis of the information on the fault reason; determining whether or not to report a management system of the fault on the basis of the restoration basis information and filtering information, and generating subject to be reported classification information on whether or not the fault corresponds to a subject to be reported to the management system; and transmitting the information on the fault reason to the management system when the fault is determined to correspond to the subject to be reported on the basis of the subject to be reported classification information.

According to another aspect of the present disclosure, there is provided a controller-based fault management apparatus that manages a fault occurring in a network. The apparatus includes: a fault event registering unit receiving information on a reason of the fault occurring in the network, and generating restoration basis information on the fault on the basis of the information on the fault reason; a fault event filtering unit determining whether or not to report a management system of the fault on the basis of the restoration basis information and filtering information, and generating subject to be reported classification information on whether or not the fault corresponds to a subject to be reported to the management system; and a fault event reporting unit transmitting the information on the fault reason to the management system when the fault is determined to correspond to the subject to be reported on the basis of the subject to be reported classification information.

Embodiment of the present disclosure may be applied commonly to the above method and apparatus.

According to an embodiment of the present disclosure, the filtering information may correspond to information on a fault type that requires fault restoration, and correspond to information received from the management system.

According to an embodiment of the present disclosure, the subject to be reported classification information may be information generated on the basis of a result of the determining of whether or not to report the management system of the fault, and correspond to information representing that the fault corresponds or not to the subject to be reported to the management system.

According to an embodiment of the present disclosure, when the fault is determined to correspond to be subject to be reported to the management system on the basis of the subject to be reported classification information, the information on the fault reason may be stored. In addition, when a request for information on the fault is received from the management system, the stored information on the fault reason may be transmitted to the management system.

According to an embodiment of the present disclosure, the restoration basis information may correspond to information required from the management system when performing fault restoration. Herein, the restoration basis information may include at least one piece of information on an entity where the fault has occurred (managed entity), a location of a fault event, a fault event occurrence indicator, a fault event release indicator, and a fault event occurrence time (time stamp).

According to an embodiment of the present disclosure, temporal information on a time at which the information on the fault reason is activated may be received, and the temporal information may be stored as temporal information on a fault event occurrence time. In addition, temporal information on a time at which the information on the fault reason is de-activated may be received, and the temporal information may be stored as temporal information on a fault event release time.

It is to be understood that the foregoing summarized features are exemplary aspects of the following detailed description of the present invention without limiting the scope of the present invention.

The present disclosure can improve efficiency in network usage when a fault occurs in a network.

The present disclosure can achieve rapid fault restoration by using a SDN controller (or network management system) when the fault occurs in the network.

The present disclosure can rapidly transfer fault information to a SDN controller when network equipment detects the fault.

Effects that may be obtained from the present invention will not be limited to only the above described effects. In addition, other effects which are not described herein will become apparent to those skilled in the art from the following description.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view showing general SDN controller-based restoration;

FIG. 2 is a view corresponding to a configuration diagram of a controller-based fault management system according to an embodiment of the present disclosure;

FIG. 3 is a view of a configuration diagram of a management function within network equipment (Management function diagram of network element) according to an embodiment of the present disclosure;

FIG. 4 is a view showing a configuration diagram of a controller-based fault management apparatus according to an embodiment of the present disclosure;

FIG. 5 is a view of a flowchart of the controller-based fault management system according to an embodiment of the present disclosure;

FIG. 6 is a view of a flowchart of the controller-based fault management apparatus according to an embodiment of the present disclosure; and

FIG. 7 is a view of a detailed functional block diagram of CBR fault management according to an embodiment of the present disclosure (Functional block diagram of CBR management).

### DETAILED DESCRIPTION OF THE INVENTION

Hereinafter, the embodiments of the present disclosure will be described in detail with reference to accompanying drawings so that the embodiments may be easily implemented by those skilled in the art. However, the present disclosure may be realized in various forms, and it is not limited to the embodiments described herein.

In the drawings, publicly known functions and configurations that are judged to be able to make the purport of the present disclosure unnecessarily obscure will not be illustrated. In addition, parts not related to the description of the present disclosure in the drawings are omitted, and like parts are denoted by similar reference numerals.

In the present disclosure, if a component were described as “connected”, “coupled”, or “linked” to another component, they may mean the components are not only directly “connected”, “coupled”, or “linked” but also are indirectly “connected”, “coupled”, or “linked” via one or more additional components. In addition, it will be understood that the terms “comprises”, “comprising”, or “includes” or “including” when used in this specification, specify the presence of one or more other components, but do not preclude the presence or addition of one or more other components unless defined to the contrary.

In the present disclosure, it will be understood that although the terms first and second are used herein to describe various elements, these elements should not be limited by these terms. Accordingly, within the scope of the present disclosure, a first component in one embodiment may be referred to as a second component in another embodiment, and likewise, a second component in one embodiment may be referred to as a first component in another embodiment.

In the present disclosure, the components that are distinguished from each other are intended to clearly describe the respective features, and do not necessarily mean that the components are separated. That is, a plurality of components may be integrated into one hardware or software unit, or one component may be distributed into a plurality of hardware or software units. Therefore, even if not mentioned otherwise, such integrated or distributed embodiments are included in the scope of the present disclosure.

In the present disclosure, components described in various embodiments are not necessarily required components, and some may be optional components. Therefore, an embodiment composed of a subset of components described in an embodiment is also included in the scope of the present disclosure. In addition, embodiments including other components in addition to the components described in the various embodiments are included in the scope of the present disclosure.

Definitions of terms used in the present disclosure are below.

In the present disclosure, transmission equipment may man network equipment using a connection-oriented method. In addition, the transmission equipment may be called network equipment. Herein, as an example of the present disclosure, the transmission equipment may correspond to an MPLS (multiprotocol label switching) router, an OTN (optical transport network), MPLS-TP, WDM (wavelength division multiplexing) equipment, etc., but it is not limited thereto.

In the present disclosure, a network management system may mean a system for restoring a fault occurring within a network, and managing the network. Herein, in an example, the network management system may correspond to a SDN controller, but it is not limited thereto.

Hereinafter, embodiments of the present disclosure will be described with reference to the accompanying drawings.

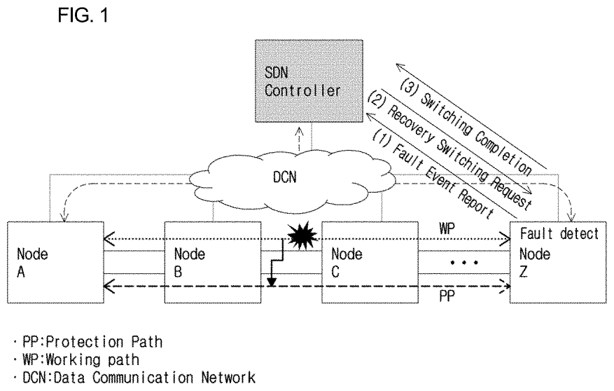

FIG. 1 is a view showing general SDN controller-based restoration. In detail, FIG. 1 shows a SDN controller-based restoration performed by a SDN controller, network equipment, and a control management network (data communication network (DCN) connecting the SDN controller and the network equipment.

The corresponding process may be divided into three steps described below.

The first step may correspond to a step of reporting, by the network equipment having detected a fault in a working path, the SDN controller of the fault, and may correspond to “(1) Fault Event Report” of FIG. 1. The second step may correspond to a step of determining, by the SDN controller, a protection path, and requesting network equipment to set the protection path as a backup path, and may correspond to “(2) Recovery Switching Request” of FIG. 1. The third step may correspond to a step of switching, by the network equipment, a fault path (working path) to the backup path, and reporting the SDN controller of the setting when the setting is completed, and may correspond to “(3) Switching Completion” of FIG. 1. Herein, the present disclosure relates to a fault management method within the network equipment of the step of reporting, by the network equipment, the SDN controller of fault information (event).

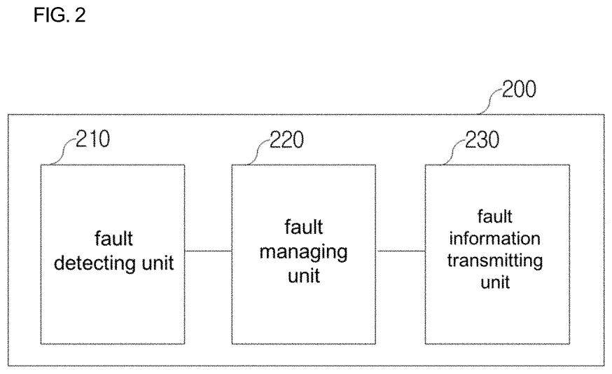

FIG. 2 is a view corresponding to a configuration diagram of a controller-based fault management system according to an embodiment of the present disclosure.

The present disclosure relates to a method of rapidly transferring, by the transmission equipment having detected a fault signal, the fault signal to a network management system when a fault occurs in a network. In other words, the present disclosure relates to a fault event management method in the transmission equipment.

A controller-based fault management system 200 of the present disclosure may include a fault detecting unit 210, a fault managing unit 220, and a fault information transmitting unit 230.

Herein, the fault detecting unit 210 may detect a fault signal in a network. In detail, the fault detecting unit 210 may detect that a fault has occurred on an arbitrary connection path in the network. Herein, the connection path in the network may correspond to a concept of including a node or link.

In addition, the fault detecting unit 210 may transmit information on the detected fault signal to the fault managing unit 220. Herein, in an example of the present disclosure, the fault detecting unit 210 may transmit to the fault managing unit 220 information on a fault reason as the information on the fault signal.

Herein, in the present disclosure, the information on the fault reason may correspond to information on a reason why the fault has occurred in the network. In addition, the information on the fault reason may correspond to restoration basis information used when generating information that is used later for restoring the fault in the network by the management system.

The fault managing unit 220 may perform a function of managing a fault on the basis of the controller. Herein, the fault managing unit 220 may perform a function of registering a fault event, a function of performing filtering on the fault event, and a function of reporting the management system of the fault event.

According to an embodiment of the present disclosure, when the fault managing unit 220 registers a fault event (Fault Event Registration), the fault managing unit 220 may receive information on a reason of the fault that has occurred in the network from the fault detecting unit 210.

The fault managing unit 220 may generate basis information on fault restoration on the basis of the information on the fault reason.

Herein, in the present disclosure, the basis information on the fault restoration may correspond to information required by the network management system when restoring the network. In addition, in an example, in the present disclosure, the restoration basis information may correspond to necessary information requested by the SDN controller when restoring the network on the basis of the SDN controller.

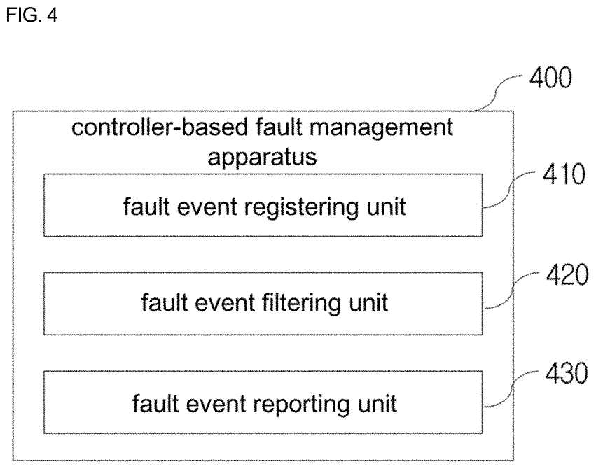

Herein, a function of registering a fault event of the fault managing unit 220 (Fault Event Registration) will be described in detail in a fault event registering unit 410 of FIG. 4.

According to an embodiment of the present disclosure, when the fault managing unit 220 performs filtering on a fault event (Fault Event Filtering), the fault managing unit 220 may determine whether or not to report the management system of the fault on the basis of the restoration basis information and filtering information. In addition, the fault managing unit 220 may generate subject to be reported classification information on whether or not the fault occurring in the network corresponds to a subject to be reported to the management system.

Herein, in the present disclosure, the filtering information may correspond to information on a fault type where fault restoration is required. Herein, the fault type where fault restoration is required may correspond to a significant or serious fault that switching to a backup path within the network is required.

According to an embodiment of the present disclosure, filtering information may correspond to information received from the management system, and correspond to information prestored in an apparatus of the present disclosure. In addition, according to an embodiment of the present disclosure, filtering information may correspond to information on serious faults where path switching is required and which is preset or predefined by a network operator or user.

Herein, according to an embodiment of the present disclosure, filtering information may correspond to information where faults that possibly occur are classified into a fault requiring path switching, and a fault not requiring path switching. In detail, each fault may be defined as a significant or serious fault requiring path switching, or as a minor fault not requiring path switching. Herein, according to an embodiment of the present disclosure, a fault requiring path switching may be predefined as “reported”. On the contrary, a fault not requiring path switching may be predefined as “not reported”. In addition, the filtering information may be data including the above-described classification information.

Herein, in the present disclosure, subject to be reported classification information may correspond to a result obtained from the fault event filtering unit that determines whether or not a fault occurred in the network is reported to the management system. According to an embodiment of the present disclosure, subject to be reported classification information may correspond to information representing that a fault corresponds to a subject to be reported” or “subject not to be reported” to the management system. In detail, the subject to be reported classification information may correspond to information generated on the basis of a result of determination on whether a fault currently occurring in network corresponds to a subject to be reported or to a subject not to be reported. In addition, the subject to be reported classification information may mean information in which a fault occurred in the network is classified into a subject to be reported or to a subject not to be reported to the management system.

According to an embodiment of the present disclosure, when the fault managing unit 220 reports the management system of a fault event (Fault Event Reporting), it may be determined that the fault corresponds to a subject to be reported on the basis of subject to be reported classification information.

In addition, the fault managing unit 220 may transfer corresponding information to the fault information transmitting unit 230 when the fault is determined to corresponds to a subject to be reported such that information on a fault reason is transmitted to the management system.

The fault information transmitting unit 230 may transmit a signal to the management system that a fault has occurred in the network. In addition, the fault information transmitting unit 230 may receive and transmit signals on fault inquires and reports occurring in the management system and an external apparatus. Herein, the external apparatus may mean equipment in the network other than the controller-based fault managing apparatus of the present disclosure. In addition, the external apparatus may correspond to the network management system, and the SDN controller, and it is not limited to the above-described example.

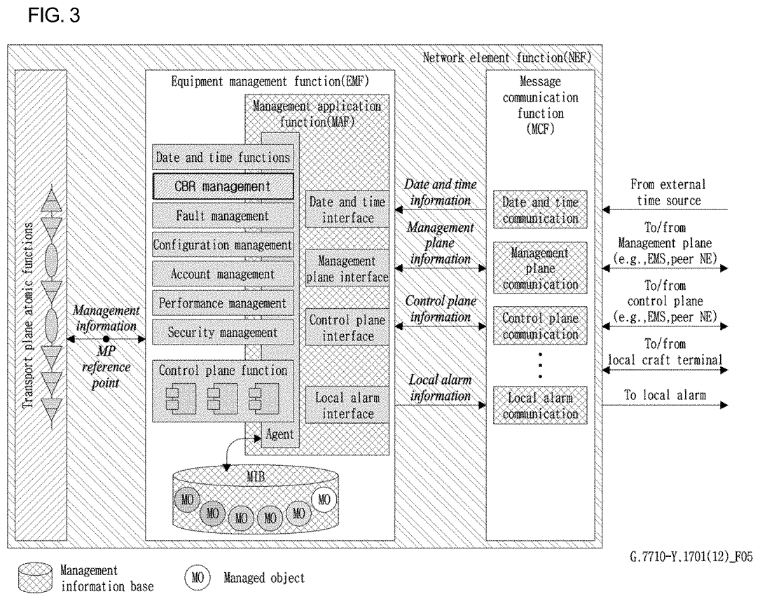

FIG. 3 is a view of a view of a configuration diagram of a management function within network equipment (management function diagram of network element) according to an embodiment of the present disclosure.

ITU-T G.7710 (common equipment management function requirements) proposes equipment management functions (EMFs) within transmission equipment which are common to various transmission methods. Herein, FCAPS functions (fault management, configuration management, account management, performance management, and security management) for managing transmission equipment are disclosed.

In detail, FIG. 3 shows an example where the controller-based restoration (CBR) apparatus and method of the present disclosure is applied to the configuration diagram of the function within the transmission equipment (network element function (NEF)) proposed by ITU-T G.7710. The CBR management function is a logical entity as an independent function, so it can be located inside the control plane function or the fault management function of the EMF.

Herein, block functions included in the network element function (NEF) may be identical to block functions of ITU-T G.7710. The network element function (NEF) may be configured with a transport plane atomic function (TPAF) block, an equipment management function (EMF) block, and a message communication function (MCF) block.

Herein, the transport plane atomic function (TPAF) block may perform data exchanging and transmission, and detect a network fault. In addition, the equipment management function (EMF) block may perform a function of controlling and managing the transmission equipment. The message communication function (MCF) block may perform a function of processing a communication message between the transmission equipment and the external apparatus.

Herein, in an embodiment of the present disclosure, the present disclosure may be employed by adding the controller-based restoration (CBR) method to the configuration of the above-described network element function (NEF).

Herein, among the blocks of the network element function (NEF) of FIG. 3, essential functions required in the present disclosure have been employed in FIG. 2. In an example, the fault detecting unit 210 may detect a fault in a network as the transport plane atomic function (TPAF) block. In addition, the fault information transmitting unit 230 may perform a function of processing a communication message between the transmission equipment and the external apparatus as the message communication function (MCF) block.

Herein, the fault managing unit 220 may correspond to the controller-based restoration (CBR) block of FIG. 3. In addition, the controller-based restoration (CBR) block may be employed in the equipment management function (EMF) block. In addition, according to an example of the present disclosure, the controller-based restoration (CBR) block may perform a function of managing a fault signal on the basis of the controller.

A fault signal transferring process for the controller-based restoration proposed in the present disclosure is as below. The transport plane atomic function (TPAF) block may provide all connection paths passing through the network equipment, and report the equipment management function (EMF) block of a fault when the fault occurs in an arbitrary connection path (or node/link). The reported fault signal is managed by being transferred to the controller-based restoration (CBR) management function of the equipment management function (EMF) block, and transferred to the external SDN controller (or management system) through the message communication function (MCF) block.

FIG. 4 shows a configuration diagram of the controller-based fault management apparatus according to an embodiment of the present disclosure.

The present disclosure relates to a method of transferring, by the transmission equipment that has detected a fault, the fault signal to the network management system when the fault occurs in a network. In other words, the present disclosure relates to a fault event management method of the transmission equipment.

According to the current ITU-T international standard (G.7710), the network equipment detects a fault signal, and then issues a warning (alarm) and transfers a warning signal to the external apparatus when the fault signal lasts 2.5 seconds or more. Accordingly, it takes at least 2.5 seconds for the SDN controller to receive the warning signal from the network equipment. In order to overcome such a problem, the present disclosure proposes a method of directly transferring a fault signal (fault) to the SDN controller rather than the warning signal.

In the present disclosure, the controller-based fault management apparatus 400 may be configured with a fault event registering unit 410, a fault event filtering unit 420, and a fault event reporting unit 430. Herein, in the present disclosure, the controller-based fault management apparatus 400 may be a concept corresponding to the fault managing unit 220 of FIG. 2.

The fault event registering unit 410 may receive information on a reason of a fault occurring in the network. In addition, the fault event registering unit 410 may generate basis information on fault restoration on the basis of the information on the fault reason.

Herein, the restoration basis information may include an entity where the fault has occurred (managed entity), a location where the fault event has occurred, a fault event occurring indication, a fault event releasing indication, a fault event occurring time (time stamp), etc., but it is not limited to the above example. In addition, the restoration basis information may include at least one piece of the above mentioned information.

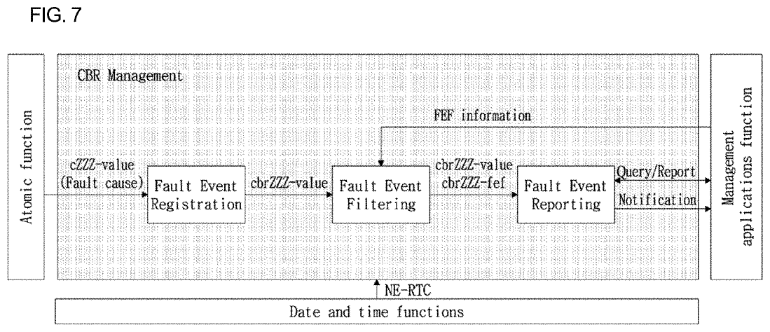

The fault event registering unit 410 may issue a fault event occurrence and a fault event release. Herein, the fault event registering unit 410 may store temporal information on a time at which a fault event occurrence and a fault event release are issued. Herein, the temporal information may be provided from the outside, and according an embodiment of the present disclosure, a date and time functions block of FIG. 7 may provide temporal information that is used for issuing fault event occurrence/release, etc. to the CBR management function, but it is not limited thereto.

Herein, when the fault event registering unit 410 issues a fault event occurrence, temporal information on a time at which information on a fault reason is activated may be received from the outside. In addition, the fault event registering unit 410 may store the received temporal information as temporal information on the fault event occurrence. In detail, when the fault event registering unit 410 issues (or registers) that a fault (controller-based fault management event) has occurred, a time at which information on a fault reason (fault cause) is activated in the fault event registering unit 410 is represented as a time stamp on the fault event occurrence. In addition, according to an example of the present disclosure, a time stamp may correspond to a time at which information on a fault reason (fault cause) is activated in an input of the fault event registering unit 410.

Meanwhile, when the fault event registering unit 410 issues a fault event release (clearing), information on a time at which the information on a fault reason is de-activated may be received from the outside. In addition, the fault event registering unit 410 may store the received temporal information as information on a fault event release. In detail, when the fault event registering unit 410 issues (or registers) that a controller-based fault management event has been released (clearing), a time at which information on a fault reason (fault cause) is de-activated in the fault event registering unit 410 may be represented as a time stamp on the fault event release. In addition, according to an example of the present disclosure, a time stamp may correspond to a time at which information on a fault reason (fault cause) is de-activated in an input of the fault event registering unit 410.

Subsequently, the fault event registering unit 410 may transfer restoration basis information generated by the above-described method to the fault event filtering unit 420.

The fault event filtering unit 420 may identify, among received fault signals, significant or serious fault types that require switching to a backup path. In other words, the fault event filtering unit 420 may determine whether or not to report management system of a fault that has occurred in the network on the basis of the restoration basis information and filtering information. In addition, the fault event filtering unit 420 may generate subject to be reported classification information on whether or not a fault corresponds to a subject to be reported to the management system. In addition, the fault event filtering unit 420 may transfer restoration basis information and the generated subject to be reported classification information to the fault event reporting unit 430.

In other words, the fault event filtering unit 420 may determine whether or not a fault currently occurring corresponds to a subject to be reported to the management system by using filtering information that is information on a fault that requires fault restoration. In addition, the fault event filtering unit 420 may generate subject to be reported classification information corresponding to a result of determining whether or not each fault corresponds to a subject to be reported.

In other words, the fault event filtering unit 420 may determine whether or not the fault currently occurring corresponds to a significant fault that has to be reported to the management system on the basis of the above-described filtering information. Subsequently, the subject to be reported classification information that is the result of the determination may be generated.

In an example, when a specific fault is determined as a significant error, the specific fault may be stored in filtering information as a fault requiring path switching. The fault event filtering unit 420 may generate subject to be reported classification information where the fault is classified into a subject to be reported, and transfer the generated subject to be reported classification information to the fault event reporting unit 430 when the fault currently occurring corresponds to the above-described specific fault. In addition, when the specific fault is determined as a minor error, the specific fault may be stored in filtering information as a fault not requiring path switching. When a fault currently occurring corresponds to the above-described specific fault, the fault event filtering unit 420 may generate subject to be reported classification information where the fault is classified into a subject not to be reported, and transfer the generated subject to be reported classification information to the fault event reporting unit 430.

The fault event reporting unit 430 may transfer to the management system fault information that is classified into a subject to be reported in the subject to be reported classification information.

When the fault is determined to correspond to a subject to be reported on the basis of the subject to be reported classification information, the fault event reporting unit 430 may transmit information on a fault reason to the management system. In addition, the fault event reporting unit 430 may transmit stored information on a fault reason to the management system when the management system transmits a request for the information on the fault.

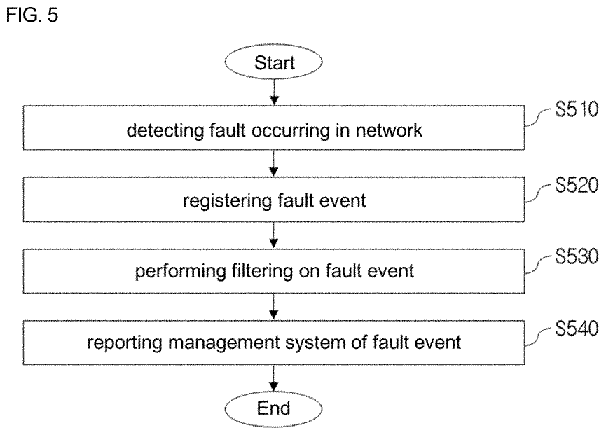

FIG. 5 is a view of a flowchart of a controller-based fault management system according to an embodiment of the present disclosure.

First, in S510, the fault detecting unit 210 may detect a fault occurring in a network, and transfer information on the fault to the fault managing unit 220.

Subsequently, in S520, the fault managing unit 220 may register a fault event according to the above-described method, in S530, perform filtering on the fault event, and in S540, report the management system of the fault event.

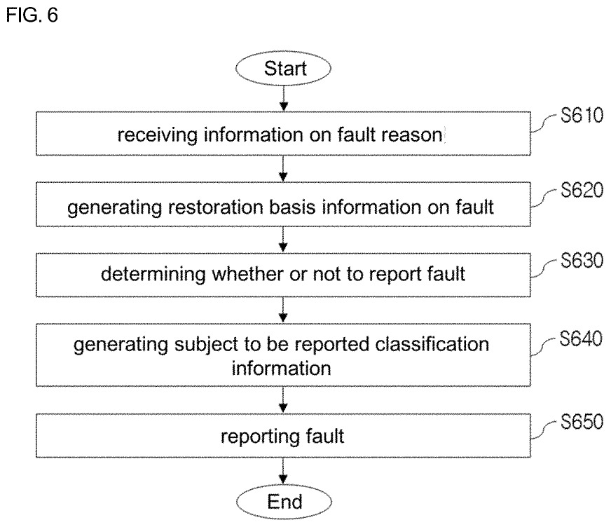

FIG. 6 is a view of a flowchart of a controller-based fault management apparatus according to an embodiment of the present disclosure.

When the controller-based fault management apparatus manages a fault occurring in a network, first, in S610, the fault event registering unit 410 may receive information on a reason of the fault occurring in the network. Subsequently, in S620, the fault event registering unit 410 may generate restoration basis information on the fault on the basis of the information on the fault reason.

In S630, the fault event filtering unit 420 may determine whether or not to report management system of the fault on the basis of the restoration basis information and filtering information. Subsequently, in S640, the fault event filtering unit 420 may generate subject to be reported classification information representing whether or not the fault corresponds to a subject to be reported to the management system.

When the fault is determined to be a subject to be reported on the basis of the subject to be reported classification information, in S650, the fault event reporting unit 430 may transmit the information on the fault reason to the management system.

FIG. 7 is a view of a detailed functional block diagram of CBR fault management according to an embodiment of the present disclosure (Functional block diagram of CBR management).

In detail, FIG. 7 shows an internal block diagram of CBR management configured with three major functional blocks which are fault event registration, fault event filtering, and fault event reporting. In other words, FIG. 7 is a view corresponding to an example employed with reference to FIG. 3. Herein, FIG. 7 may be a view corresponding to an information transfer process and operations of the fault managing unit 220 included in the controller-based fault management system 200 of the present disclosure. In addition, in an example, FIG. 7 may be a view corresponding to an information transfer process and operations of the controller-based fault management apparatus 400 of FIG. 4.

Herein, in FIG. 7, in order to accurately represent an information transfer, for example, a process of transferring information is represented by using information transfer indicators. The above example may correspond to an example of the present disclosure, and correspond to the above-described information.

For example, a cZZZ-value may be a concept corresponding to information on a fault reason in the present disclosure. A cbrzzz-value may be a concept corresponding to restoration basis information on the fault in the present disclosure. A cbrzzz-fef may be a concept corresponding to subject to be reported classification information of the present disclosure. EhF information may be a concept corresponding to filtering information in the present disclosure.

In addition, each block represented in FIG. 7 may be a concept corresponding to the unit described in FIG. 4 of the present disclosure. For example, a fault event registration block may be a concept corresponding to the fault event registering unit 410. A fault event filtering block may be a concept corresponding to the fault event filtering unit 420. A fault event reporting block may be a concept corresponding to the fault event reporting unit 430.

The fault event registration block may be notified with information on a fault reason (cZZZ-value) from a transport plane atomic function (TPAF) block. In addition, the fault event registration block may generate data (restoration basis information, cbrZZZ-value) used (required) in the controller-based restoration (SDN controller based restoration), and transfer the generated data to the fault event filtering block.

The cbrZZZ-value may include a subject (where fault occurs) entity (managed entity), a location of a fault event, a fault event occurrence or release indicator, a fault event occurrence time (time stamp), etc. In CBR event issuing (declaration), a time stamp may represent a time at which “fault cause” is activated in input of the fault event registration. In CBR event releasing (clearing), a time stamp may represent a time at which “fault cause” is de-activated in input of the fault event registration.

A fault event filtering block may perform a function of identifying, among received fault signals, significant or serious fault types that require switching to a backup path. The fault event filtering block may be provided with information on significant fault types that require switching to a backup path from the SDN controller (or management system) through FEF information, and store the information in advance. Subsequently, the fault event filtering block may determine whether or not to report the SDN controller of the received fault by using information on significant fault types described above when the occurrence of the fault is notified from the fault event registration block. Accordingly, the fault event filtering block may transfer whether or not to report SDN controller of the fault by including the same in cbrZZZ-fef by referring to FEF information when a fault signal is received from the fault event registration, and transfer the same with the cbrZZZ-value to the fault event reporting block.

A network operator may define significant fault types that require path switching, and the defined fault types may be transferred to the transmission equipment through FEF information. When a received fault type corresponds to a significant (serious) fault type that is defined that path switching is required (defined as “reported”) by EEF information, the FEF may be transferred to the fault event reporting block by being represented “reported” in the cbrZZZ-fef. On the contrary, when a received fault type corresponds to a minor fault that does not require path switching (defined as “not reported”) by FEF information, the EhT may be transferred to the fault event reporting block by being represented as “not reported” in the cbrZZZ-fef.

The fault event reporting block may transfer a fault that is represented as “reported” to the SDN controller. Subsequently, the fault event reporting block may be used for storing information on all reported faults, and performing synchronization on fault information with the external system (including the SDN controller). Accordingly, when inquires on fault information are received from the external system including the SDN controller, the fault event reporting block may reply for the same by using the stored information.

A date and time functions block may provide temporal information used when issuing a fault event occurrence/release to the CBR management.

The present disclosure relates to an invention for providing of VTN (virtual tenant network) protection switching services. Network service outages due to network failures can cause huge losses for service providers. In a current transmission network where the SDN concept is not applied, a backup path is additionally set, in preparation for a network fault, for all connection paths when setting the same. For this reason, more than half of the installed network paths remain idle.

On the contrary, when a fault is restored by using the SDN controller, and a fault occurs in a network path, the SDN controller detects the fault and rapidly generates a backup path so as to take data traffic detour. Accordingly, a backup path has not to be procured in advance, and thus network usage efficiently can be increased remarkably.

Herein, the fault signal detected in the network equipment has to be transferred rapidly to the SDN controller so as to minimize service interruptions due to the fault. The present disclosure proposes a method of rapidly transferring such fault signals. When the present disclosure is applied, it is confirmed that a time taken to path switching is reduced from about 4 seconds to 80 ms in the self-established test environment.

Although the exemplary methods described in the present disclosure are represented as a series of operations for clarity of description, the order of the steps is not limited thereto. When necessary, the steps may be performed simultaneously or in a different order. In order to realize the method according to the present disclosure, other steps may be added to the illustrative steps, some steps may be excluded from the illustrative steps, or some steps may be excluded while additional steps may be included.

The various embodiments of the present disclosure are not intended to list all possible combinations, but to illustrate representative aspects of the present disclosure. The matters described in the various embodiments may be applied independently or in a combination of two or more.

Further, the various embodiments of the present disclosure may be implemented by hardware, firmware, software, or combinations thereof. In the case of implementation by hardware, implementation is possible by one or more application specific integrated circuits (ASICs), digital signal processors (DSPs), digital signal processing devices (DSPDs), programmable logic devices (PLDs), field programmable gate arrays (FPGAs), general processors, controllers, micro controllers, microprocessors, or the like.

The scope of the present disclosure includes software or machine-executable instructions (for example, an operating system, an application, firmware, a program, or the like) that cause operations according to the methods of the various embodiments to be performed on a device or a computer, and includes a non-transitory computer-readable medium storing such software or instructions to execute on a device or a computer.

What is claimed is:

1. A method of managing a network fault, wherein a controller-based fault management apparatus manages a fault occurring in a network, the method comprising:
receiving information on a reason of the fault occurring in the network, and generating restoration basis information on the fault on the basis of the information on the fault reason;
determining whether or not to report a management system of the fault on the basis of the restoration basis information and filtering information, and generating subject to be reported classification information on whether or not the fault corresponds to a subject to be reported to the management system; and
transmitting the information on the fault reason to the management system when the fault is determined to correspond to the subject to be reported on the basis of the subject to be reported classification information.

2. The method of claim 1, wherein the filtering information corresponds to information on a fault type that requires fault restoration, and corresponds to information received from the management system.

3. The method of claim 1, wherein the subject to be reported classification information is information generated on the basis of a result of the determining of whether or not to report the management system of the fault, and corresponds to information representing that the fault corresponds or not to the subject to be reported to the management system.

4. The method of claim 1, wherein when the fault is determined to correspond to be subject to be reported to the management system on the basis of the subject to be reported classification information, the information on the fault reason is stored.

5. The method of claim 4, when a request for information on the fault is received from the management system, the stored information on the fault reason is transmitted to the management system.

6. The method of claim 1, wherein the restoration basis information corresponds to information required from the management system when performing fault restoration.

7. The method of claim 6, wherein the restoration basis information includes at least one piece of information on an entity where the fault has occurred (managed entity), a location of a fault event, a fault event occurrence indicator, a fault event release indicator, and a fault event occurrence time (time stamp).

8. The method of claim 1, wherein temporal information on a time at which the information on the fault reason is activated is received, and the temporal information is stored as temporal information on a fault event occurrence time.

9. The method of claim 1, wherein temporal information on a time at which the information on the fault reason is de-activated is received, and the temporal information is stored as temporal information on a fault event release time.

10. A controller-based fault management apparatus, wherein the controller-based fault management apparatus manages a fault occurring in a network, the apparatus comprising:
a fault event registering unit receiving information on a reason of the fault occurring in the network, and generating restoration basis information on the fault on the basis of the information on the fault reason;
a fault event filtering unit determining whether or not to report a management system of the fault on the basis of the restoration basis information and filtering information, and generating subject to be reported classification information on whether or not the fault corresponds to a subject to be reported to the management system; and
a fault event reporting unit transmitting the information on the fault reason to the management system when the fault is determined to correspond to the subject to be reported on the basis of the subject to be reported classification information.

11. The apparatus of claim 10, wherein the filtering information corresponds to information on a fault type that requires fault restoration, and correspond to information received from the management system.

12. The apparatus of claim 10, wherein the subject to be reported classification information is information generated on the basis of a result of the determining of whether or not to report the management system of the fault, and corresponds to information representing that the fault corresponds or not to the subject to be reported to the management system.

13. The apparatus of claim 10, wherein when the fault is determined to correspond to the subject to be reported to the management system on the basis of the subject to be reported classification information, the fault event reporting unit stores the information on the fault reason.

14. The method of claim 13, when a request for information on the fault is received from the management system, the fault event reporting unit transmits the stored information on the fault reason to the management system.

15. The apparatus of claim 10, wherein the restoration basis information corresponds to information required from the management system when performing fault restoration.

16. A controller-based fault management system, wherein the system manages a fault occurring in a network, the system comprising:
a fault detecting unit detecting whether or not the fault occurs in the network, and when the fault occurs, transmitting information on a fault reason to a fault managing unit; and
the fault managing unit,
wherein the fault managing unit: generates restoration basis information on the fault on the basis of the information on the fault reason; determines whether or not to report a management system of the fault on the basis of the restoration basis information and filtering information; generates subject to be reported classification information on whether or not the fault corresponds to a subject to be reported to the management system; and when the fault is determined to correspond to the subject to be reported on the basis of the subject to be reported classification information, transmits the information on the fault reason to the management system.

17. The method of claim 16, wherein the filtering information corresponds to information on a fault type that requires fault restoration, and corresponds to information received from the management system.

18. The method of claim 16, wherein the subject to be reported classification information is information generated on the basis of a result of the determining of whether or not to report the management system of the fault, and corresponds to information representing that the fault corresponds or not to the subject to be reported to the management system.

19. The method of claim 16, wherein when the fault is determined to correspond to the subject to be reported to the management system on the basis of the subject to be reported classification information, the information on the fault reason is stored.

20. A method of managing a network fault, wherein a controller-based fault management system manages a fault occurring in a network, the method comprising:
detecting whether or not the fault occurs in the network, and when the fault occurs, receiving information on a fault reason;
generating restoration basis information on the fault on the basis of the information on the fault reason;
determining whether or not to report a management system of the fault on the basis of the restoration basis information and filtering information, and generating subject to be reported classification information on whether or not the fault corresponds to a subject to be reported to the management system; and
when the fault is determined to correspond to the subject to be reported on the basis of the subject to be reported classification information, transmitting the information on the fault reason to the management system.
